(19) United States
(12) Patent Application Publication
(10) Pub. No.: US 2002/0067413 A1
(43) Pub. Date: Jun. 6, 2002

(54) Vehicle night vision system

(76) Inventor: Dennis Patrick McNamara, Del Rio, TX (US)

Correspondence Address: Nelson D. Nolte, WALLENSTEIN & WAGNER, LTD., 311 South Wacker Drive, 53rd Floor, Chicago, IL, 60606, US

(21) Appl. No.: 09/729,304

(22) Filed: Dec. 4, 2000

(51) Int. Cl. H04N 5/225

(52) U.S. Cl. 348/216; 348/229; 348/362

(57) ABSTRACT

A system and method for controlling a night vision system in an automobile is disclosed. Disclosed is a vehicle night vision camera comprising an optical lens and a low light CCD image sensor array which converts an image received by the optical lens into an electronic signal. A signal processor receives the electronic signal and is capable of automatically controlling a gain of the electronic signal. A timing controller automatically controls an electronic iris size of the CCD image sensor array A display which converts the electronic signal into a image on the display Finally, a luminance threshold detector determines the luminance of the electronic signal and generates a luminance threshold detector output signal for enabling or disabling the automatic gain control of the electronic signal and the automatic electronic iris size of the CCD image sensor array

### DESCRIPTION

1. Technical Field

The present invention relates generally to night vision systems for an automobile More specifically the present invention relates to a night vision system for an automobile which can be easily added to a vehicle by attaching it to the windshield.

2. Background of the Invention

Automobile night vision systems are known. These systems use infrared cameras to detect sources of heat in the path of the automobile in order to provide the driver with information about many obstacles which may be in the road ahead of the automobile, but beyond the range of the automobile's headlights Information can be provided on a display for the driver or, optionally, projected onto the windshield of the automobile

However, in the past, inexpensive systems have not been capable of detecting faraway objects well enough to be helpful to the driver. Therefore, vehicle night vision systems have not been widely implemented in automobiles. However, with advances in the field of charge couple device (CCD) image sensors, sensors used to convert the image into an electronic signal, a need has developed for a system which can utilize the increased sensitivity of these cameras in an automobile. On the open road, where there are fewer sources of infrared light in the “background” and driving speeds are faster, it is advantageous to use the full sensitivity of the improved CCD image sensor to view obstacles that are located farther away from the vehicle However, in the city where speeds are slow and more light is present, the CCD image sensor, with the its increased sensitivity, is quickly overloaded and obstacles cannot be discerned.

Additionally, referring to FIG. 1, the arrangement of a night vision system has been such that for increasing the field of view 100 for a driver 102 in a vehicle 104 the system has generally comprised of an IR camera 106 mounted in the front of a vehicle 104, video processing circuitry 108 located somewhere within the vehicle 104, and a display 11O located in a third position within the vehicle. Additionally, the display 110 may be projected with a mirror 112 onto the windshield of the vehicle 114 In the past, such systems have been large and bulky and have required a time consuming installation process of the system into the vehicle for which it will be used. As such aftermarket vehicle night vision systems have not become popular Additionally, such systems as used in vehicles have not provided for a simple system by which the driver can direct the camera in different directions

The present invention solves these and other problems

### SUMMARY OF THE INVENTION

The present invention discloses a vehicle night vision camera comprising an optical lens and a low light CCD image sensor array which converts an image received by the optical lens into an electronic signal. A signal processor receives the electronic signal and is capable of automatically controlling a gain of the electronic signal A timing controller automatically controls an electronic iris size of the CCD image sensor array. A display converts the electronic signal into an image on the display Finally, a luminance threshold detector determines the luminance of the electronic signal and generates a luminance threshold detector output signal for enabling or disabling the automatic gain control of the electronic signal and/or the automatic electronic iris size of the CCD image sensor array.

Also disclosed is a method of controlling a night vision system for a vehicle comprising the steps of projecting an image through a lens onto a low light CCD image sensor array, converting the image into an electronic signal with the low light CCD image sensor array, detecting the luminance of the image, automatically controlling the gain of the electronic signal when the luminance of the image is above a threshold level, setting the gain to maximum when the luminance of the image is below the threshold level, automatically controlling the electronic iris of the CCD image sensor array when the luminance of the image is above the threshold level, and setting the iris size to maximum when the luminance of the image is below the threshold level.

Other features and advantages of the invention will be apparent from the following detailed description taken in conjunction with the drawings

### BRIEF DESCRIPTION OF THE DRAWINGS

FIG. 1 is a diagram of the placement of a infrared camera in a vehicle;

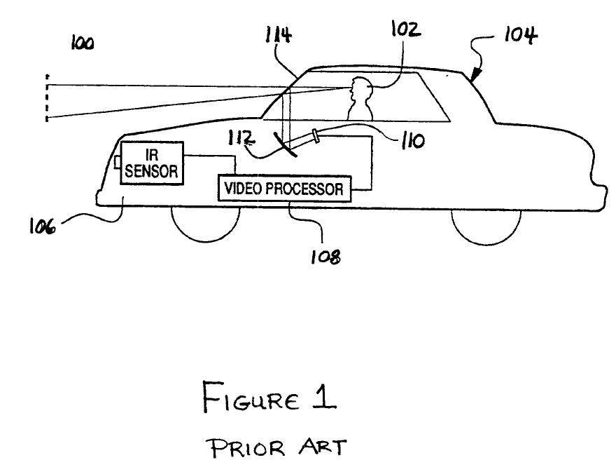

FIG. 2 is a block diagram of a circuit in accordance with the present invention,

FIG. 3 is diagram indicating the arrangement of an infrared camera in an automobile according to an embodiment of the present invention, and

FIG. 4 is diagram indicating the arrangement of an infrared camera in an automobile according to an embodiment of the present invention

### DETAILED DESCRIPTION OF THE PREFERRED EMBODIMENT

While this invention is susceptible of embodiment in many different forms, there will herein be described in detail preferred embodiments of the invention with the understanding that the present disclosure is to be considered as exemplifications of the principles of the invention and is not intended to limit the broad aspects of the invention to the embodiments illustrated

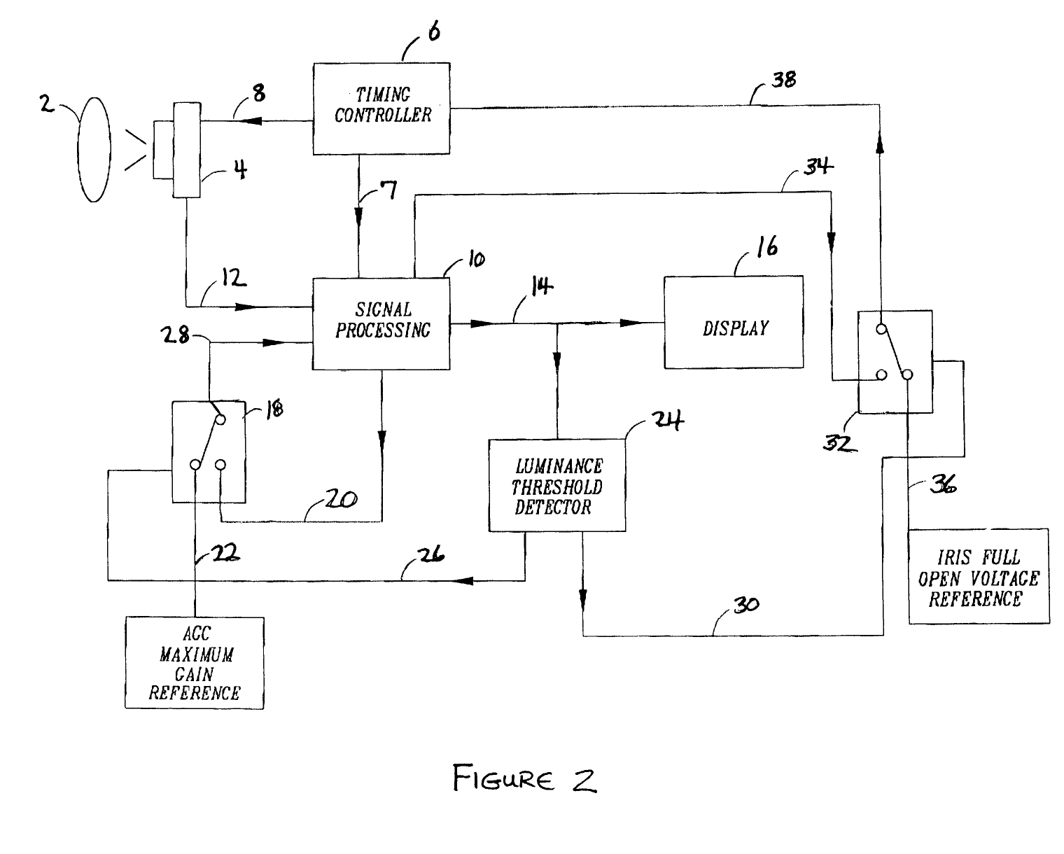

Referring to FIG. 2, the preferred embodiment of the present invention comprises a lens 2 with a focal number, or f-stop, of 0 8 and a 25-mm focal length to acquire an image of a scene in front of the vehicle. The lens projects the image onto a charge coupled device (CCD) image sensor 4. The CCD image sensor 4 is, preferably, a ½ inch monochromatic low light CCD area sensor having spectral sensitivity in the infrared region, such as the ICX248AL available from the Sony Corporation The CCD image sensor 4 receives an iris control signal on a iris control line 8 from a timing controller 6, such as the CXD2463R available from the Sony Corporation The timing controller 6 also generates timing signals for a signal processor 10, such as the CXA1310AQ available from the Sony Corporation, on a timing controller output line 7

The signal processor 10 performs the basic signal processing of images received from the CCD image sensor on an image sensor line 12 The signal processor 10 also adds sync signals which are necessary to provide an EIA standard video output signal on a video output line 14 The video output line 14 is connected to a display 16, preferably a liquid crystal display (LCD) The image created by the display 16 can be optionally reflected onto a windshield of the vehicle.

The signal processor 10 also incorporates a center screen photometry feature in which only the center portion of the screen is sampled for in order to control electronic iris and automatic gain control (AGC) functions. A first analog switch 18 is connected to an AGC output of the signal processor 10 through an AGC output line 20. The switch 18 opens or closes the AGC feedback loop by alternatively connecting the AGC output line 20 or an AGC maximum gain reference signal on an AGC maximum gain reference line 22 The switch 18 is control by a first luminance detector output signal of a luminance threshold detector 24 on a first luminance threshold detector output line 26 The output of the switch 18 is connected to an AGC input of the signal processor 10 through an AGC input line 28

The luminance threshold detector 24 also has a second luminance threshold detector output signal provided on a second luminance threshold detector output line 30 The second luminance threshold detector output signal controls a second analog switch 32. The switch 32 alternatively connects an iris control output signal from the signal processor 10 on an iris control output line 34 and an iris full open reference signal on a iris full open reference line 36 to an iris control input signal line 38.

The present system operates by detecting images having wavelengths in the range of 400 and 1000 nM and displaying the images on the display 16. Specifically, the lens 2 directs light onto the CCD image sensor 4 On intervals controlled by the timing controller 6, the CCD image sensor 4 sends the detected images to the signal processor 10 which transmits the signal to the display 16 and the luminance threshold detector 24

The luminance threshold detector 24 detects the luminance of the extreme top portion of the video signal, or about the first ten horizontal video lines The luminance level of the extreme top portion is then averaged and compared to a preset reference luminance If the detected and averaged luminance level is less than the preset reference, the first and second luminance output signals go high In response, the first analog switch 18 connects the AGC maximum gain reference signal to the AGC input line 28 of the signal processor 10, and the second analog switch 32 connects the iris full open reference line 36 to the iris control input line 38. As a result, the signal processor 10 sets the ,AGC to maximum and the iris control to full open. When the above condition is met, the system is in the “rural” mode or the mode with greatest light sensitivity.

If the detected and averaged luminance level is more than the preset reference, the first and second luminance output signals go low. In response, the first analog switch 18 connects the AGC output line 20 to the AGC input line 28 of the signal processor 10, and the second analog switch 32 connects the iris control output line 34 to the iris control input line 38 As a result, the feedback loops for automatic gain control and automatic iris control are closed. When the above condition is met, the AGC and electronic iris control loops are re-established and the system is in the “urban” mode, or the mode with the ability to control higher ambient light levels.

Several variations of the preferred embodiment are evident without departing from the scope of the invention, as defined by the claims. For example, the first and/or second analog switches could additionally be manually controllable by the driver of the vehicle in order to set the system in “urban” or “rural” mode. The present system could also implement a manually variable luminance threshold for the luminance threshold detector 24 to control the luminance at which the “urban” or “rural” modes are automatically implemented by the luminance threshold detector 24.

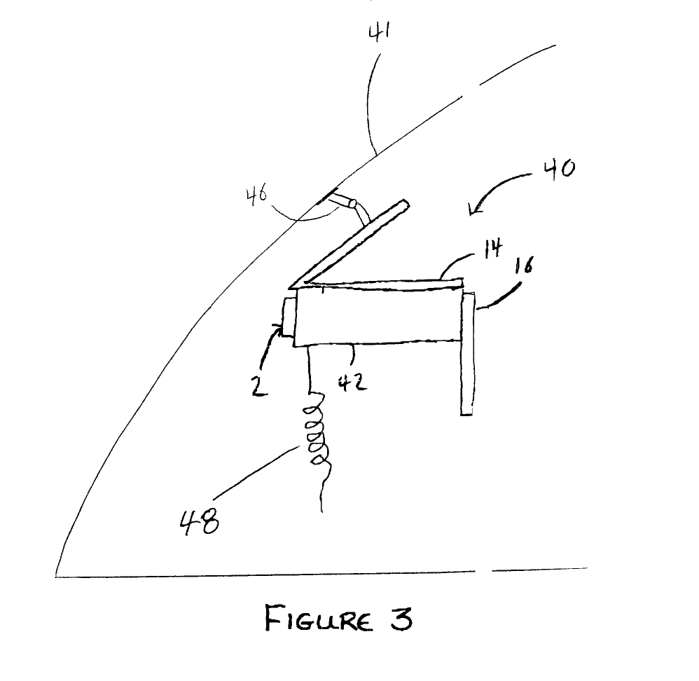

The present system can also be arranged in a compact package which allows a driver to quickly install the night vision system into a vehicle and to quickly and easily direct the camera in any direction. Referring to FIG. 3, the present system comprises a single, compact device 40 which can be attached to the windshield 41 of a vehicle. The package 40 comprises the lens 2, a case 42 for containing the image processing circuitry of the camera and the display 16. Also provided is a bracket 44 and a securement 46 for attaching the package 40 to the windshield 41 of the vehicle Preferably, the securement 46 is a ball and socket device attached to both the windshield of the automobile and the bracket 44 The ball and socket device allows for easy adjustment of the position of the device 40. The securement 46 can also be hook and loop material, suction cups, double sided tape, or any method used to attach one object to another. Also provided is a wire 48 for connecting to the vehicle's power supply for providing power to the camera It is also contemplated that the camera may also be operated from rechargeable or nonrechargeable batteries.

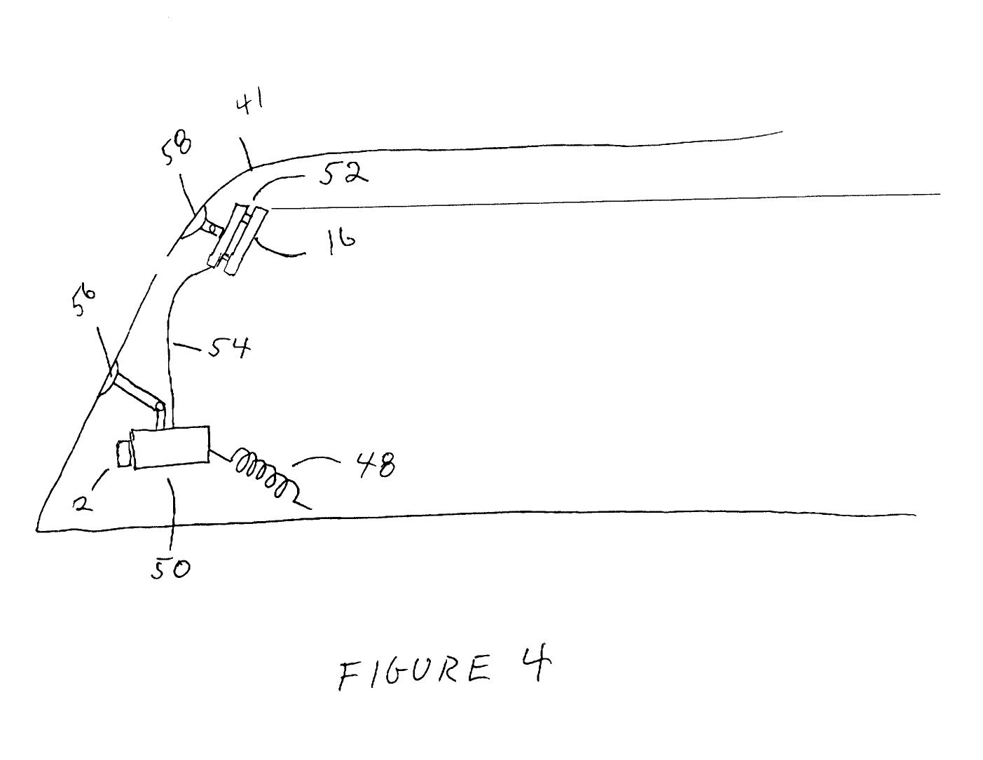

Referring to FIG. 4, in a preferred embodiment, the present system comprises a separate camera portion 50 and display portion 52 attached the windshield 41 of a vehicle and each device 50, 52 connected by a wire 54 The camera portion 50 comprises a lens 2 for detecting an image in front of the vehicle and circuitry for converting the image into an electrical signal, as described above. The display portion 52 comprises a display 16. The two portions communicate through the wire 54, though it is also contemplated that the camera portion 50 and the display portion 52 can communicate via wireless communication, such as radio frequency. Both the camera portion 50 and the display portion 52 comprise securements 56, 58 so that each portion 50,52 can separately be positioned on the windshield 41 of a vehicle As above the securements 56, 58 are preferably ball and socket devices In this manner each portion 50, 52 can be placed on the windshield 41 in a position to be of most benefit to the driver, i.e. the camera portion 50 positioned for the best vantage point of the road in front of the vehicle and the display portion 52 positioned for optimal viewing by the driver

It will be understood that the invention may be embodied in other specific forms without departing from the spirit or central characteristics thereof The present embodiments, therefore, are to be considered in all respects as illustrative and not restrictive, and the invention is not to be limited to the details given herein

What I claim is:

1. A vehicle night vision camera comprising.
an optical lens for receiving an image,
a low light CCD image sensor array which converts the received image into an electronic signal;
a signal processor which receives the electronic signal and is capable of automatically controlling a gain of the electronic signal,
a timing controller which is capable of automatically controlling an electronic iris size of the CCD image sensor array;
a display which converts the electronic signal into a image on the display, and
at least one luminance threshold detector which determines the luminance of the electronic signal and generates a luminance threshold detector output signal for enabling or disabling the automatic gain control of the electronic signal and the automatic electronic iris size of the CCD image sensor array

2. The vehicle night vision system of claim 1 wherein the at least one luminance threshold detector detects the luminance at the upper portion of the image.

3. The vehicle night vision system of claim 2 wherein the luminance threshold detector detects the luminance of approximately the top ten scan lines of the image.

4. The vehicle night vision system of claim 1 wherein the automatic gain control and iris control is determined by detecting the luminance at the center of the Image.

5. The vehicle night vision system of claim 1 wherein the luminance threshold detector output signal controls an analog switch for alternatively electrically completing an automatic gain feedback loop of the signal processor or electrically connecting an automatic gain control reference signal to the signal processor

6. The vehicle night vision system of claim 5 wherein the automatic gain control reference signal is manually variable by the driver of the vehicle

7. The vehicle night vision system of claim 1 wherein the luminance threshold detector output signal controls an analog switch for alternatively electrically completing an iris control signal from the signal processor to the timing controller or electrically connecting an iris control reference signal to the timing controller.

8. The vehicle night vision system of claim 7 wherein the iris control reference signal is manually variable by the driver of the vehicle.

9. A method of controlling a night vision system for a vehicle comprising the steps of
projecting an image through a lens onto a low light CCD image sensor array,
converting the image into an electronic signal with the low light CCD image sensor array,
detecting the luminance of the image;
automatically controlling the gain of the electronic signal when the luminance of the image is beyond a threshold level;
setting the gain to maximum when the luminance of the image is below the threshold level,
automatically controlling the electronic iris of the CCD image sensor array when the luminance of the image is above the threshold level; and
setting the iris size to maximum when the luminance of the image is below the threshold level

10. The method of claim 9 wherein the step of detecting the luminance of the image comprises detecting the luminance of the upper portion of the image

11. The method of claim 10 wherein the step of detecting the luminance of the upper portion of the image comprises detecting the luminance at approximately the uppermost ten scan lines of the image

12. The method of claim 9 wherein the step of automatically controlling the gain of the electronic signal when the luminance of the image is beyond a threshold level comprises automatically controlling the gain of the electronic signal when the luminance of a center area of the image is beyond a threshold level

13. A system for controlling a night vision system for a vehicle comprising
means for projecting an image through a lens onto a low light CCD image sensor array,
means for converting the image into an electronic signal with the low light CDD image sensor array;
means for detecting the luminance of the image;
means for automatically controlling the gain of the electronic signal when the luminance of the image is beyond a threshold level;
means for setting the gain to maximum when the luminance of the image is below the threshold level;
means for automatically controlling the electronic iris of the CCD image sensor array when the luminance of the image is beyond the threshold level; and
means for setting the iris size to maximum when the luminance of the image is below the threshold level.

14. The system of claim 13 wherein the means for detecting the luminance of the image comprises means for detecting the luminance of the upper portion of the image

15. The method of claim 14 wherein the means for detecting the luminance of the upper portion of the image comprises means for detecting the luminance at approximately the uppermost ten scan lines of the image.

16. The method of claim 13 wherein the step of automatically controlling the gain of the electronic signal when the luminance of the image is beyond a threshold level comprises automatically controlling the gain of the electronic signal when the luminance of a center area of the image is beyond a threshold level

17. A night vision camera for a vehicle comprising
a camera portion;
a camera portion securement for attaching the camera portion to the windshield of an automobile,
a display portion;
a display portion securement for attaching the display portion to the windshield of an automobile

18. The night vision system of claim 17 wherein the camera portion securement and the display portion securement each comprises a ball and socket device

19. The night vision system of claim 18 wherein the ball and socket device are attached to the windshield with an adhesive.

20. The night vision system of claim 18 wherein the camera portion and the display portion are assembled in a single case and the camera portion securement and the display portion securement comprise a single securement

21. A night vision system for a vehicle comprising
a camera portion;
a camera portion mounted within the interior of the vehicle,
a display portion;
a display portion securement for attaching the display portion to the windshield of an automobile.
